(19) United States
(12) Patent Application Publication
(10) Pub. No.: US 2007/0075857 A1
(43) Pub. Date: Apr. 5, 2007

(54) Video surveillance system

(75) Inventors: Cheng-Jyh Chang, Taipei (TW); Chieh-Jung Liao, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Avermedia Technologies, Inc.

(21) Appl. No.: 11/377,833

(22) Filed: Mar. 16, 2006

(30) Foreign Application Priority Data
Oct. 5, 2005 (TW) 094134867

(51) Int. Cl. G08B 13/00

(52) U.S. Cl. 340/541

(57) ABSTRACT

A video surveillance system is used with a plurality of video sources and a monitor. The system includes a video surveillance control device in communication with the video sources and the monitor; and a video surveillance control program operated in the video surveillance control device for controlling the video surveillance control device to output a display signal to the monitor, thereby showing a user interface on the monitor. A user interface editor is provided in the video surveillance control device for allowing a user to edit the user interface according to his or her demand.

### FIELD OF THE INVENTION

The present invention relates to a video surveillance system, and more particularly relates to a digital video recorder surveillance system used with a plurality of surveillance cameras and a monitor.

### BACKGROUND OF THE INVENTION

Please refer to FIG. 1 which is a functional block diagram illustrating a digital video recorder surveillance system (DVRs) in widespread use. The system includes a plurality of video cameras 101, 102 . . . 10n, a control box 11, and a monitor 12. The plurality of video cameras 101, 102 . . . 10n output n video signals to the control box 11 for further processing. Then, a video output signal is generated and transmitted to the monitor 12 for display.

For facilitating the operation of the surveillance system, an application program executed by the system provides a graphical user interface, as shown in FIG. 2, on the monitor 12 so that the user can operate and control the surveillance system in a convenient manner.

However, since the display area of the monitor 12 is limited, it is very difficult to meet all requirements. A crowded view is unavoidable while the video signals outputted by all the n video cameras are sharing the display area of the monitor 12 with the entire user interface of the surveillance system. Furthermore, the layout of the user interface of the conventional application program is fixed and cannot be edited once the whole system is ready for sale. Consequently, for satisfying various operating situations, all possible control function keys and pull-down menus are involved in the user interface in advance. As a result, the user interface seems more crowded and complex, which bothers the user very much. Therefore, a friendly user interface is still in demand.

### SUMMARY OF THE INVENTION

The present invention provides a video surveillance system adapted to be used with a plurality of video sources and a monitor. The system includes a video surveillance control device in communication with the video sources and the monitor; and a video surveillance control program operated in the video surveillance control device for controlling the video surveillance control device to output a display signal to the monitor, thereby showing a user interface on the monitor. A user interface editor operated in the video surveillance control device is provided for allowing a user to edit the user interface of his or her own.

In an embodiment, the video sources are a plurality of surveillance cameras.

In an embodiment, the video surveillance control device is a digital video recorder surveillance control device.

In an embodiment, the user interface shown on the monitor is a graphical user interface.

In an embodiment, the user interface editor allows the user to edit the user interface by steps of: providing a menu for the user to select a desired panel from the menu; deleting control objects currently loaded in the user interface; opening a window and adjusting the region of the window; and loading information stored in a specific skin configuration file and showing control objects in the user interface according to the information.

In an embodiment, the information stored in the specific skin configuration file includes dimension of the window, image files used by the window, amount of the control objects, and positions, dimensions and icons of each of the control objects.

In an embodiment, the user interface editor is integrated with the video surveillance control program.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a functional block diagram illustrating the conventional digital video recorder surveillance system;

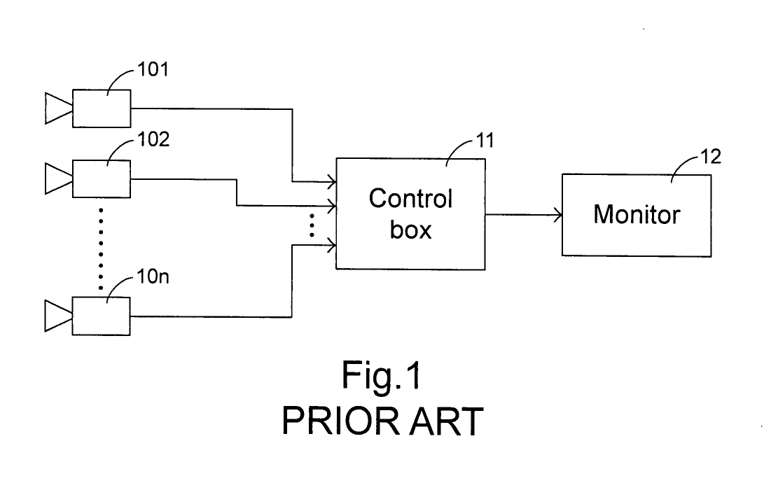

FIG. 2 is a schematic diagram showing a graphical user interface used by the conventional digital video recorder surveillance system;

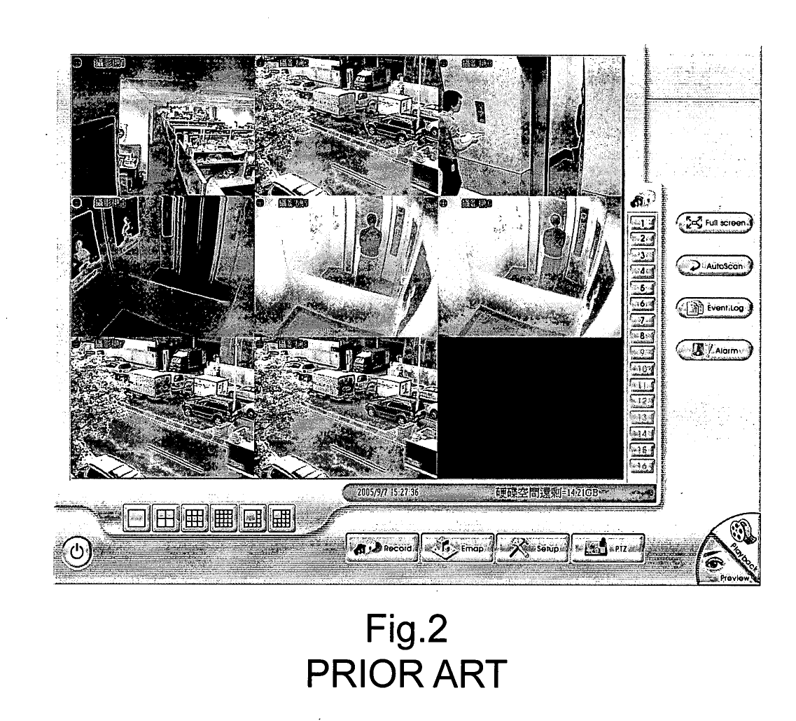

FIG. 3 is a functional block diagram illustrating a preferred embodiment of a video surveillance system according to the present invention; and

FIG. 4 is a flow chart exemplifying the operation steps of the user interface editor according to the present invention.

### DETAILED DESCRIPTION OF PREFERRED EMBODIMENTS

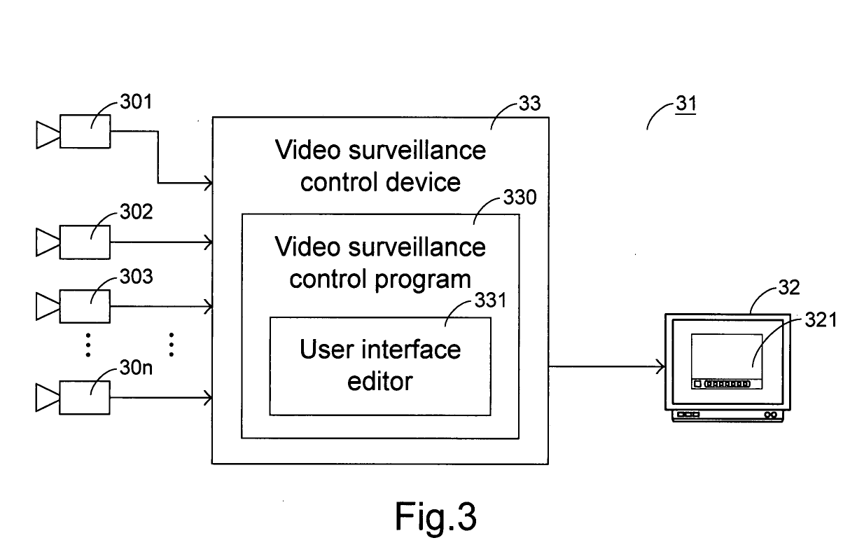

Refer to FIG. 3, which is a functional block diagram illustrating a preferred embodiment of a video surveillance system according to the present invention. The video surveillance system 31 includes a video surveillance controller device 33 adapted to be used with a plurality of video sources 301, 302 . . . 30n, surveillance cameras for example, and a monitor 32. A video surveillance control program 330 and a user interface editor 331 are operated in the video surveillance control device 33. The video surveillance controller device 33 is implemented by a control box of a digital video recorder surveillance system (DVRs) in this embodiment, and the video surveillance control program 330 is an application program for the user to control the digital video recorder surveillance system. For facilitating the user in operating the system, the video surveillance control program 330 controls the video surveillance controller device 33 to output a display signal to the monitor 32 and shows a user interface 321, preferably a graphical user interface, on the monitor 12. However, due to the various needs and application surroundings for different users, an identical layout of the control objects cannot satisfy every user. Therefore, the present invention provides the user interface editor 331 operated in the video surveillance controller device 33. The user interface editor 331 allows the user to edit the user interface 321 shown on the monitor 32 to omit some unnecessary control objects and change the objects of the user interface 321, for example, the control function keys, the pull-down menus, or the layout of objects. Therefore, the user can change the control function keys, pull-down menus and the layout of objects in response to different operation surroundings, and thus improve the user interface 321 to meet one's requirement. The user interface editor 331 can be integrated with the video surveillance control program 330 to provide a more powerful application program.

Several important points are considered in designing the user interface editor 331 of the present invention. First, of all, the skins of different user interfaces 321 can be stored in different directories and each skin has a corresponding configuration file for recording the user interface information. Furthermore, there must be a unique ID for each control object, e.g. play control, record control, set control, etc.

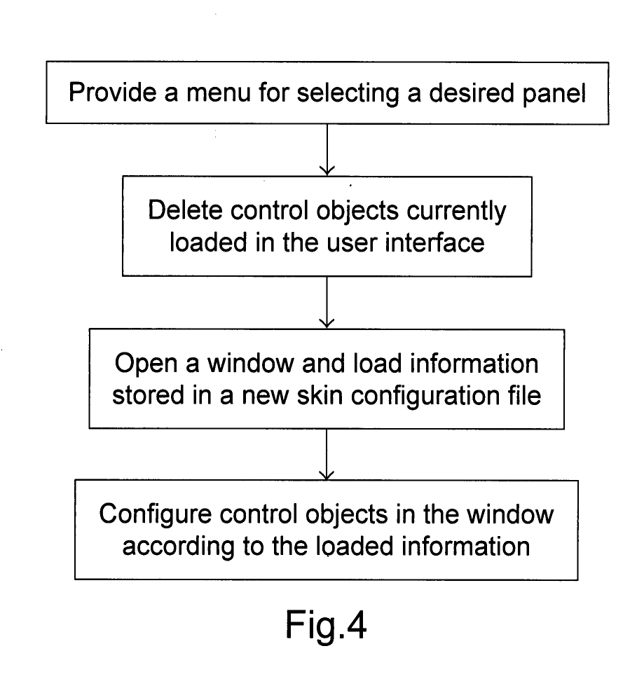

According to the above-mentioned design points, the user interface editor 331 allows the user to edit the user interface 321 by the steps in the flow chart showing in FIG. 4. First of all, the user interface editor 331 provides a menu (or a panel selector) on the monitor 32. The user can choose a desired panel from the menu. In response to the user's selection, the control objects currently loaded in the user interface are cleared to be ready for loading information stored in a new skin configuration file. The information includes dimension of the window, image files used by the window, amount of various control objects, and positions, dimensions and icons of each control object. Next, the user interface editor 331 opens a window, defines the dimension of the window, loads image files to be used, and paste the used image files or icons on the window. The next step is to determine the properties of various control objects. The properties include relative positions of the control objects in the window, dimensions of the control objects, ID values for identifying different control objects. Relevant images or icons are loaded in the memory for changing the images according to the operation status of the control object. For example, clicked and non-clicked control objects are often represented by different images or icons and the files corresponding to different operation status are loaded in the memory in advance. Next, the input signal from mouse or keyboard is processed. According to the relative positions and dimensions of the control objects in the window, it can be determined which control object is selected. Since there is a unique ID for each control object, the program can execute a specific function according to the ID. For example, an ID named ID_{—play is assigned to a play control object. Once the program realizes that the play control object is selected, the program will execute the play function.}

According to the above description, the invention solves the problems of the conventional video surveillance system. The user interface 321 shown on the monitor 32 is not unchangeable any more. Hence, the user can design various customized user interface 321 for different applying surroundings.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A video surveillance system adapted to be used with a plurality of video sources and a monitor, comprising:
a video surveillance control device in communication with the plurality of video sources and the monitor;
a video surveillance control program operated in said video surveillance control device for controlling said video surveillance control device to output a display signal to the monitor, thereby showing a user interface on the monitor; and
a user interface editor operated in said video surveillance control device for allowing a user to edit said user interface shown on the monitor.

2. The video surveillance system according to claim 1, wherein the plurality of video sources are a plurality of surveillance cameras.

3. The video surveillance system according to claim 1, wherein said video surveillance control device is a digital video recorder surveillance control device.

4. The video surveillance system according to claim 1, wherein said user interface shown on the monitor is a graphical user interface.

5. The video surveillance system according to claim 1, wherein said user interface editor allows the user to edit said user interface by steps of:
providing a menu for the user to select a desired panel from said menu;
deleting control objects currently loaded in said user interface;
opening a window and adjusting the region of said window; and
loading information stored in a specific skin configuration file and showing control objects in said user interface according to said information.

6. The video surveillance system according to claim 5, wherein said information stored in said specific skin configuration file includes dimension of said window, image files used by said window, amount of said control objects, and positions, dimensions and icons of each of said control objects.

7. The video surveillance system according to claim 1, wherein said user interface editor is integrated with said video surveillance control program.
